(19) United States
(12) Patent Application Publication
(10) Pub. No.: US 2019/0263104 A1
(43) Pub. Date: Aug. 29, 2019

(54) Method Of Making A Multiple-Layer Flexible Film

(71) Applicant: ACPO, Ltd., Oak Harbor, OH (US)

(72) Inventors: Dennis M. Liebman, Oak Harbor, OH (US); Dean T. Dupont, Oak Harbor, OH (US)

(21) Appl. No.: 16/286,803

(22) Filed: Feb. 27, 2019

Related U.S. Application Data
(60) Provisional application No. 62/635,696, filed on Feb. 27, 2018.

(51) Int. Cl. B32B 37/22; B32B 38/00; B32B 37/12; B32B 27/08

(52) U.S. Cl. CPC B32B 37/223; B32B 38/145; B32B 37/12; B32B 2553/00; B32B 2255/10; B32B 2255/26; B32B 27/08

(57) ABSTRACT

A method of making a multiple-layer flexible film includes providing a first flexible film. The first flexible film includes a first polymeric layer. A printed layer is formed over a first major surface of the first polymeric layer. The first flexible film is directed to a lamination device. A second flexible film is directed to the lamination device. The second flexible film includes a heat sealable polymeric layer and an adhesive layer disposed over the heat sealable polymeric layer. The first flexible film is laminated to the second flexible film utilizing the lamination device to form a multiple-layer flexible film such that the heat sealable polymeric layer defines an outer surface of the multiple layer flexible film and the adhesive layer is disposed on the printed layer.

### BACKGROUND

The invention relates to a method of making a multiple-layer flexible film.

Flexible packaging structures are known to be utilized in food packaging. Such structures can be formed by converting multiple-layer flexible films. However, the multiple-layer films known in the art require complex processes and tooling to be made.

It would be advantageous to provide a method that is less complex and does not require the use of specialized equipment to make a multiple-layer flexible film.

### BRIEF SUMMARY

Embodiments of a method of making a multiple-layer, flexible film are provided.

In an embodiment, the method of making a multiple-layer flexible film comprises providing a first flexible film. The first flexible film comprises a first polymeric layer. A printed layer is formed over a first major surface of the first polymeric layer. The first flexible film is directed to a lamination device. A second flexible film is directed to the lamination device. The second flexible film comprises a heat sealable polymeric layer and an adhesive layer disposed over the heat sealable polymeric layer. The first flexible film is laminated to the second flexible film utilizing the lamination device to form a multiple-layer flexible film such that the heat sealable polymeric layer defines an outer surface of the multiple layer flexible film and the adhesive layer is disposed on the printed layer.

### BRIEF DESCRIPTION OF THE SEVERAL VIEWS OF THE DRAWING

The above, as well as other advantages of the embodiments will become readily apparent to those skilled in the art from the following detailed description when considered in the light of the accompanying drawings in which:

FIG. 1 depicts a schematic view of an embodiment of an apparatus utilized in the method of making the multiple-layer flexible film in accordance with the invention;

FIG. 2 depicts an enlarged view depicting a portion of the apparatus and an embodiment of the multiple-layer flexible film of FIG. 1;

FIG. 3 depicts an enlarged view depicting a portion of the apparatus and another embodiment of the multiple-layer flexible film of FIG. 1; and

FIG. 4 depicts an enlarged view depicting a portion of the apparatus and still another embodiment of the multiple-layer flexible film of FIG. 1.

### DETAILED DESCRIPTION

It is to be understood that the invention may assume various alternative orientations and step sequences, except where expressly specified to the contrary. It is also to be understood that the specific layers, films, methods and processes illustrated in the attached drawing, and described in the following specification are simply exemplary embodiments of the inventive concepts. Hence, specific dimensions, directions, or other physical characteristics relating to the embodiments disclosed are not to be considered as limiting, unless expressly stated otherwise.

Embodiments of a multiple-layer flexible film 10, 10A, 10B will be described below. The embodiments of the multiple-layer flexible film 10, 10A, 10B may be utilized to form a flexible packaging structure (not depicted) such as, for example, a bag, sack, pouch, or overwrap. The flexible packaging structure may then be utilized to package food items. However, it should be appreciated that the multiple-layer flexible film 10, 10A, 10B may be converted into other structures and have medical, industrial, retail, and other specialized applications.

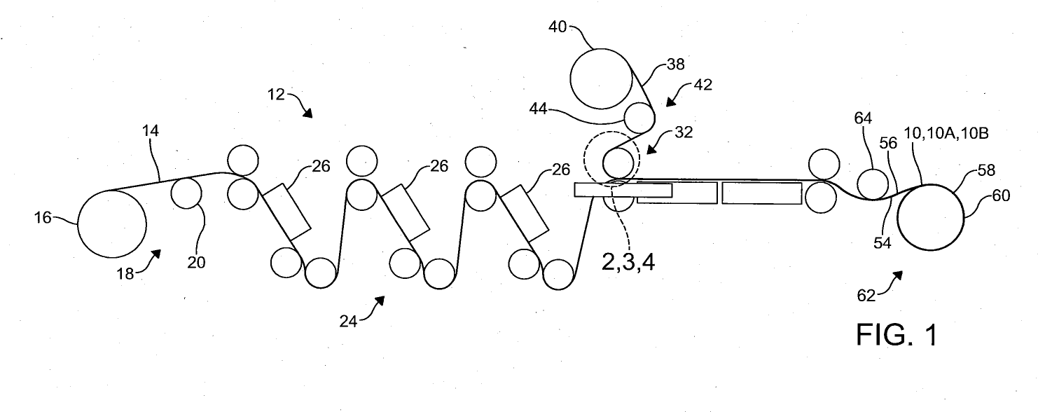

FIG. 1 illustrates an apparatus 12 which can be utilized in the method of making the multiple-layer flexible film 10, 10A, 10B. Advantageously, the multiple-layer flexible film 10, 10A, 10B may be made utilizing only the apparatus 12 illustrated in FIG. 1. Thus, the multiple-layer flexible film 10, 10A, 10B can be made without the use of multiple pieces of equipment, which reduces the cost of making the multiple-layer flexible film 10, 10A, 10B and eliminates the need to transport the unfinished flexible film between the pieces of equipment.

Referring now to FIGS. 1-4, the method comprises providing a first flexible film 14. In some embodiments, the first flexible film 14 has a thickness of 10 microns or more. Preferably, the first flexible film 14 has a thickness of 10-300 microns. In some embodiments, the first flexible film 14 has a thickness of 10-200 microns.

When provided, the first flexible film 14 is connected to the apparatus 12. Preferably, the first flexible film 14 is connected to the apparatus 12 as a roll 16. In this embodiment, the roll 16 of the first flexible film 14 is unwound at a first unwinding portion 18 of the apparatus 12. The first unwinding portion 18 may comprise an unwinding member 20, which is utilized to assist in unwinding the roll 16 of the first flexible film 14.

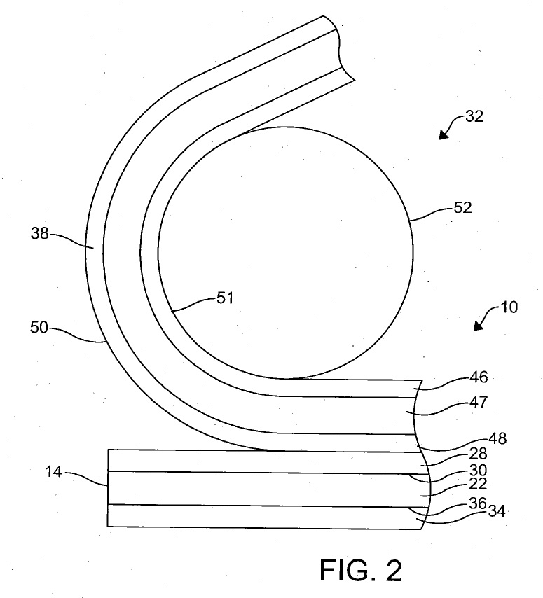

As illustrated in FIGS. 2-4, the first flexible film 14 comprises a first polymeric layer 22. The first polymeric layer 22 can be formed by extrusion, casting, or another process. The first polymeric layer 22 may comprise polyethylene, polypropylene, polyester, nylon or another material. In some embodiments, the first polymeric layer 22 is a co-extruded and multiple-layer. Preferably, the first polymeric layer 22 comprises a material which enables the first polymeric layer 22 to provide a barrier to oxygen and other gases entering or escaping the flexible packaging structure. In certain embodiments, the material utilized to form the first polymeric layer 22 is selected so that the first polymeric layer 22 can provide a barrier to moisture entering the flexible packaging structure. In certain embodiments, the first polymeric layer 22 may define a first outer surface 54 of the multiple-layer flexible film 10, 10A, 10B. When a flexible packaging structure is formed utilizing the multiple-layer flexible film 10, 10A, 10B, the first polymeric layer 22 may define the outer surface(s) of the flexible packaging structure.

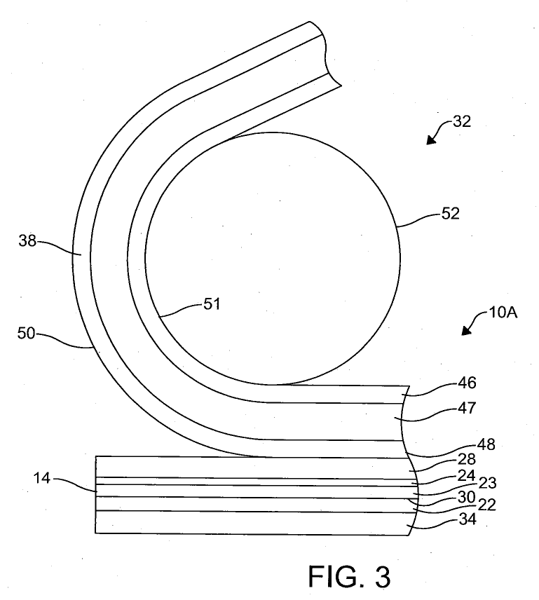

Referring now to FIG. 3, an optically enhanced polymeric layer 23 may be disposed over the first polymeric layer 22. As used herein, the phrase “disposed over” refers to the position of a layer of the multiple-layer flexible film 10, 10A, 10B across a major surface of another layer of the multiple-layer flexible film 10, 10A, 10B. In some of these embodiments, the optically enhanced polymeric layer 23 is disposed directly on a first major surface 30 of the first polymeric layer 22. The optically enhanced polymeric layer 23 is provided to enable the multiple-layer flexible film 10A to shine by reflected light. Preferably, when the optically enhanced polymeric layer 23 is provided, the multiple-layer flexible film 10A has a metallic or pearlescent appearance. In an embodiment, the optically enhanced polymeric layer 23 comprises a polymer and a pigment. Preferably, the pigment is dispersed in the polymer. In some embodiments, the pigment may be disposed in the polymer in a substantially uniform manner. A preferred polymer is an acrylic. Preferably, the pigment is formed by non-metallic materials. In an embodiment, the pigment comprises mica. In another embodiment, the pigment comprises PET. In still another embodiment, the pigment comprises a mixture of mica and PET. The pigment may be provided as powder, flakes, or in another form.

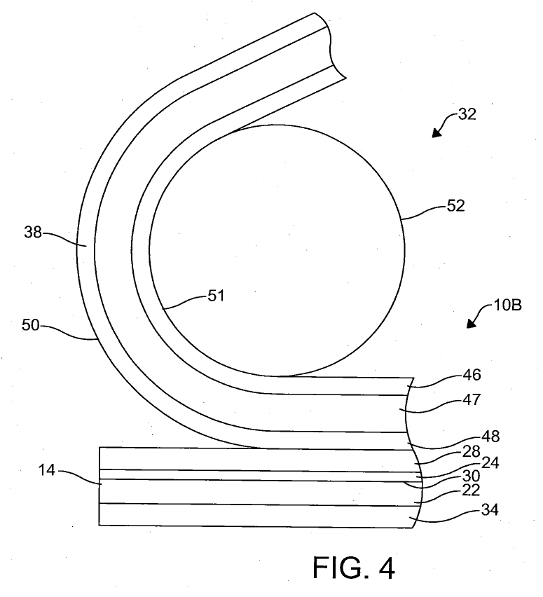

In some embodiments, like those illustrated in FIGS. 3-4, the first flexible film 14 may comprise a barrier layer 24. In these embodiments, the barrier layer 24 is disposed over the first polymeric layer 22. In an embodiment, the barrier layer 24 is disposed directly on the first major surface 30 of the first polymeric layer 22. In an embodiment, the barrier layer 24 is disposed on the optically enhanced polymeric layer 23. Preferably, when present, the barrier layer 24 is provided between the first polymeric layer 22 and the printed layer 28. The barrier layer 24 is provided to inhibit entry of moisture and/or oxygen and other gases into the flexible packaging structure. Preferably, the barrier layer 24 comprises a polymer. In other embodiments, the barrier layer 24 comprises a polymer and ceramic nanoparticles. Preferred polymers include ethylene vinyl alcohol (EVOH), polyvinylidene chloride (PVDC), and poly(vinyl alcohol) (PVOH). Ceramic nanoparticles known in the art are suitable for use in the barrier layer 24.

The printed layer 28 is formed over the first major surface 30 of the first polymeric layer 22. In certain embodiments, the printed layer 28 is formed directly on the first major surface 30 of the first polymeric layer 22. In these embodiments, there are no intervening layers that separate the printed layer 28 and the first polymeric layer 22. However, in other embodiments, one or more layers 23, 24 may separate the printed layer 28 and the first polymeric layer 22. In certain embodiments, the first polymeric layer 22 is separated from the printed layer 28 by the optically enhanced polymeric layer 23. In some embodiments, the printed layer 28 is formed on the optically enhanced polymeric layer 23. In one such embodiment, there are no intervening layers that separate the printed layer 28 and the optically enhanced polymer layer 23. In other embodiments, the printed layer 28 and the optically enhanced polymer layer 23 are separated by another layer 24. For example, in an embodiment like the one illustrated in FIG. 3, the printed layer 28 may be formed on the barrier layer 24. In this embodiment, the barrier layer 24 is disposed on the optically enhanced polymeric layer 23 and separates the optically enhanced polymeric layer 23 from the printed layer 28. Also, as illustrated in FIG. 3, the optically enhanced polymeric layer 23 is disposed on the first polymeric layer 22. In other embodiments, like the one illustrated in FIG. 4, the printed layer 28 may be formed on the barrier layer 24 and the barrier layer 24 may be disposed on the first polymeric layer 22. In these embodiments, the optically enhanced polymer layer 23 may not be included in the multiple-layer flexible film 10B.

Preferably, the printed layer 28 is formed by depositing an ink on the first major surface 30 of the first polymeric layer 22. Known varieties of inks are suitable for use in forming the printed layer 28. For example, the ink may be solvent based, water based, or a curable ink. Curable inks such as, for example, UV and heat cure inks are preferred. After forming the printed layer 28, the first flexible film 14 is directed to a lamination portion 32 of the apparatus 12.

The first flexible film 14 may also comprise a coating layer 34 which is applied to a second major surface 36 of the first polymeric layer 22. It is preferred that the coating layer 34 is applied to the first flexible film 14 before the printed layer 28 is formed. In some embodiments, the coating layer 34 may be provided to increase or decrease the tactile properties of the multiple-layer flexible film 10, 10A, 10B. In these embodiments, it is preferred that the coating layer 34 comprise a urethane or another material. When the coating layer 34 comprises a urethane, it is preferred that the urethane is crosslinked.

The coating layer 34 can be applied to the first flexible film 14 via roll coating. However, other techniques may be suitable for applying the coating layer 34 to the first flexible film 14. It should be appreciated that when the coating layer 34 is provided, the coating layer 34 may be disposed directly on the second major surface 36 of the first polymeric layer 22. In this embodiment, there are no intervening layers that separate the coating layer 34 and the first polymeric layer 22. However, the coating layer 34 is separated from the printed layer 28 by the first polymeric layer 22. When provided, the coating layer 34 may define the first outer surface 54 of the multiple-layer flexible film 10, 10A, 10B. When a flexible packaging structure is formed utilizing the multiple-layer flexible film 10, 10A, 10B, the coating layer 34 may define the outer surface(s) of the flexible packaging structure.

The method also comprises providing a second flexible film 38. In some embodiments, the second flexible film 38 has a thickness of 10 microns or more. Preferably, the second flexible film 38 has a thickness of 10-300 microns. In some embodiments, the second flexible film 38 has a thickness of 10-200 microns.

When provided, the second flexible film 38 is connected to the apparatus 12. Preferably, the second flexible film 38 is connected to the apparatus 12 as a roll 40. In this embodiment, the roll 40 of the second flexible film 38 is unwound at a second unwinding portion 42 of the apparatus 12. The second unwinding portion 42 may comprise an unwinding member 44, which is utilized to assist in unwinding the roll 40 of the second flexible film 38.

The second flexible film 38 comprises a heat sealable polymeric layer 46, which is illustrated best in FIG. 2. The heat sealable polymeric layer 46 can be formed by extrusion, casting, or another process. Advantageously, at a predetermined temperature, the heat sealable polymeric layer 46 can be sealingly attached to itself. Preferably, the predetermined temperature is such that, when the heat sealable polymeric layer 46 is sealingly attached to itself, none of the layers of the multiple-layer flexible film 10, 10A, 10B are damaged. When a flexible packaging structure is formed utilizing the multiple-layer flexible film 10, 10A, 10B, the heat sealable polymeric layer 46 defines the inner surface(s) of the flexible packaging structure. When the multiple layer flexible film 10, 10A, 10B is formed, it is preferred that the heat sealable polymeric layer 46 defines a second outer surface 56 of the multiple-layer flexible film 10, 10A, 10B.

Preferably, the material utilized to form the heat sealable polymeric layer 46 is selected so that the heat sealable polymeric layer 46 can provide a barrier to moisture entering the flexible packaging structure. A preferred material that is both heat sealable and that may provide a sufficient barrier to moisture is biaxially oriented polypropylene (BOPP). The heat sealable polymeric layer 46 may comprise other polypropylene materials such as, for example, cast polypropylene (CPP). Additionally, the material(s) utilized to form the heat sealable polymeric layer 46 may also be selected to impart the heat sealable polymeric layer 46 with properties which provide a barrier to oxygen and other gases entering and escaping the flexible packaging structure. Other polyolefin materials are suitable for use in the heat sealable polymeric layer 46. For example, the heat sealable polymeric layer 46 may comprise polyethylene, polyester, or another material. A preferred polyethylene is low density polyethylene (LDPE). A preferred polyester is polyethylene terephthalate) (PET).

In certain embodiments, the heat sealable polymeric layer 46 may comprise two or more polymers. In these embodiments, the heat sealable polymeric layer 46 may be formed by co-extrusion. In some of these embodiments, the heat sealable polymeric layer 46 may comprise two or more discrete layers. For example, when the heat sealable polymeric layer 46 is formed by co-extrusion, the heat sealable polymeric layer 46 may include a layer comprising PET and a layer comprising nylon. In other embodiments, the heat sealable polymeric layer 46 may include a layer comprising LDPE or BOPP. For example, the heat sealable polymeric layer 46 may include a layer comprising LDPE and a layer comprising high density polyethylene (HDPE). In this embodiment, the layer of HDPE may separate two layers of LDPE.

In other embodiments, the second flexible film 38 may be metalized. For example, the second flexible film 38 may comprise a metallized polymer. In one such embodiment, the second flexible film 38 may comprise the heat sealable polymeric layer 46 and a metallic layer 47. The metallic layer 47 may be provided directly on the heat sealable polymeric layer 46. The metallic layer 47 may comprise a metal or a metal oxide. In an embodiment, the second flexible film 38 may comprise a heat sealable polymeric layer 46 of PET and a metallic layer 47 of aluminum or aluminum oxide.

The second flexible film 38 comprises an adhesive layer 48. The adhesive layer 48 defines a first major surface 50 of the second flexible film 38. The heat sealable polymeric layer 46 defines a second major surface 51 of the second flexible film 38. The adhesive layer 48 is disposed over the heat sealable polymeric layer 46 such that, when the multiple-layer flexible film 10 is formed, the heat sealable polymeric layer 46 defines an outer surface 56 of the multiple layer flexible film 10. In certain embodiments, the adhesive layer 48 is applied directly on a major surface of the heat sealable polymeric layer 46. In these embodiments, there are no intervening layers that separate the heat sealable polymeric layer 46 and the adhesive layer 48. In other embodiments, the adhesive layer 48 may be applied directly on a major surface of a metallic layer 47. In these embodiments, the metallic layer 47 separates the heat sealable polymeric layer 46 from the adhesive layer 48. The adhesive layer 48 is provided prior to forming the roll 40 of the second flexible film 38. Providing the adhesive layer 48 as described above reduces the cost and complexity to manufacture the multiple-layer flexible film 10, 10A, 10B.

The adhesive layer 48 comprises an adhesive. Preferably, the adhesive is suitable for direct food contact. Additionally, it is preferred that the adhesive is of the pressure sensitive variety. Suitable pressure sensitive adhesives include acrylics, natural rubbers, synthetic rubbers and other pressure sensitive adhesives. When the adhesive comprises acrylic, it is preferred that the adhesive is an emulsion acrylic, a water based acrylic, or is a mixture of an acrylic and a urethane.

As noted above, the roll 40 of the second flexible film 38 is unwound prior to forming the multiple-layer flexible film 10, 10A, 10B. Preferably, the adhesive is ready for use in forming the multiple-layer flexible film 10, 10A, 10B once the roll 40 is unwound. The adhesive is ready for use because it does not require any chemicals such as, for example, cross-linking agents, curing such as, for example, UV or heat, or processing such as, for example, drying after the roll 40 of the second flexible film 38 is unwound in order for the adhesive to be utilized in forming the multiple-layer flexible film 10, 10A, 10B.

After unwinding the roll 40 of the second flexible film 38, the second flexible film 38 is directed to the lamination portion 32 of the apparatus 12. The lamination portion 32 comprises a lamination device 52, which is illustrated in FIG. 2. Lamination devices known in the art are suitable for use in practicing the method.

The first flexible film 14 and the second flexible film 38 are laminated to each other utilizing the lamination device 52 to form the multiple-layer flexible film 10, 10A, 10B. The lamination device applies a force to the films 14, 38 to laminate the first flexible film 14 and the second flexible film 38 to each other. The force applied to the films 14, 38 enables the adhesive to bond the first flexible film 14 to the second flexible film 38. Preferably, lamination portion 32 does not include an external heat source. In an embodiment, lamination of the first flexible film 14 and the second flexible film 38 is achieved at an ambient temperature.

In some embodiments, the multiple-layer flexible film 10, 10A, 10B has a thickness of 20 microns or more. Preferably, the multiple-layer flexible film 10, 10A, 10B has a thickness of 20-600 microns. In some embodiments, the multiple-layer flexible film 10, 10A, 10B has a thickness of 20-400 microns.

When the multiple-layer flexible film 10, 10A, 10B is formed, the first flexible film 14 defines the first outer surface 54 of the multiple-layer flexible film 10, 10A, 10B. More particularly, in certain embodiments, the first polymeric layer 22 defines the first outer surface 54 of the multiple-layer flexible film 10, 10A, 10B. In other embodiments, the coating layer 34 defines the first outer surface 54 of the multiple-layer flexible film 10, 10A, 10B. Additionally, when the multiple-layer flexible film 10, 10A, 10B is formed, the second flexible film 38 defines the second outer surface 56 of the multiple-layer flexible film 10, 10A 10B. More particularly, as noted above, the heat sealable polymeric layer 46 defines the second outer surface 56 of the multiple-layer flexible film 10, 10A, 10B. Preferably, the first outer surface 54 and the second outer surface 56 are oriented in a parallel relationship with each other. In these embodiments, the adhesive layer 48 is disposed over the printed layer 28. More particularly, it is preferred that the adhesive layer 48 is disposed directly on the printed layer 28.

The thickness of the multiple-layer flexible film 10, 10A, 10B may vary between embodiments. Also, the width of the multiple-layer flexible film 10, 10A, 10B can vary between embodiments. However, it is preferred that the multiple-layer flexible film 10, 10A, 10B has a width of 24 inches or less.

After the multiple-layer flexible film 10, 10A, 10B is formed it may be wound into a roll 58. The length of the multiple-layer flexible film 10, 10A, 10B provided in the roll 58 can be predetermined. For example, the length of the multiple-layer flexible film 10, 10A, 10B can be equal to the length of one or both of the first flexible film 14 and the second flexible film 38. It should be appreciated that the length of the multiple-layer flexible film 10, 10A, 10B can also vary between embodiments.

The roll 58 of the multiple-layer flexible film 10, 10A, 10B may further comprise a spool 60 or another member to support the multiple-layer flexible film 10, 10A, 10B. When provided, the multiple-layer flexible film 10, 10A, 10B may be disposed around the spool 60 at a winding portion 62 of the apparatus 12. The winding portion 62 may comprise a winding device 64 or another member which assists in providing the multiple-layer flexible film 10, 10A, 10B in the roll 58.

The roll 58 of the multiple-layer flexible film 10, 10A, 10B may be utilized in a secondary process to form a flexible packaging structure. In the secondary process, the roll 58 may be unwound and the multiple-layer flexible film 10, 10A, 10B can be converted into flexible packaging structures. The multiple-layer flexible film 10, 10A, 10B can be converted into flexible packaging structure by, for example, cutting a portion of the film 10, 10A, 10B to a desired length and width and then heat sealing one or more portions of the heat sealable polymeric layer 46 to itself.

The foregoing description is considered as illustrative only of the principles of the invention. Further, since numerous modifications and changes will readily occur to those skilled in the art, it is not desired to limit the invention to the exact construction and processes shown and described herein. Accordingly, all suitable modifications and equivalents may be considered as falling within the scope of the invention

1. A method of making a multiple-layer flexible film, comprising:
providing a first flexible film comprising a first polymeric layer;
forming a printed layer over a first major surface of the first polymeric layer;
directing the first flexible film to a lamination device;
directing a second flexible film to the lamination device, wherein the second flexible film comprises a heat sealable polymeric layer and an adhesive layer disposed over the heat sealable polymeric layer; and
laminating the first flexible film to the second flexible film utilizing the lamination device to form a multiple-layer flexible film such that the heat sealable polymeric layer defines an outer surface of the multiple layer flexible film and the adhesive layer is disposed on the printed layer.

2. The method of claim 1, wherein the second flexible film is provided as a roll and unwound utilizing an apparatus comprising an unwinding member.

3. The method of claim 1, wherein the first flexible film is provided as a roll and unwound utilizing an apparatus comprising an unwinding member.

4. The method of claim 1, further comprising applying a coating layer comprising a urethane to a second major surface of the first polymeric layer.

5. The method of claim 1, wherein the printed layer is formed by depositing an ink on the first major surface of the first polymeric layer.

6. The method of claim 1, further comprising winding the multiple-layer flexible film into a roll such that the multiple-layer flexible film is disposed around a spool.

7. The method of claim 1, wherein the first flexible film is laminated directly to the second flexible film such that there are no intervening layers that separate the adhesive layer and the printed layer.

8. The method of claim 1, wherein the first polymeric layer and the heat sealable polymeric layer each comprise polyethylene.

9. The method of claim 1, wherein the first polymeric layer comprises polyethylene, polypropylene, polyester, or nylon.

10. The method of claim 1, wherein the heat sealable polymeric layer comprises a polypropylene, polyethylene, or polyolefin.

11. The method of claim 1, wherein there are no intervening layers that separate the first polymeric layer and the printed layer.

12. The method of claim 1, wherein the first polymeric layer defines another outer surface of the multiple layer flexible film.

13. The method of claim 1, further comprising providing an optically enhanced polymer layer between the first polymeric layer and the printed layer.

14. The method of claim 1, further comprising providing a barrier layer between the first polymeric layer and the printed layer.

15. The method of claim 1, wherein the printed layer is formed on an optically enhanced polymer layer or a barrier layer.

16. The method of claim 4, wherein the coating layer defines another outer surface of the multiple layer flexible film.

17. The method of claim 13, wherein the optically enhanced polymer layer is disposed on the first major surface of the first polymeric layer.

18. The method of claim 14, wherein the barrier layer is disposed on the first major surface of the first polymeric layer.

19. The method of claim 14, wherein the barrier layer is disposed on an optically enhanced polymer layer.

20. The method of claim 16, wherein the optically enhanced polymer layer is separated from the printed layer by a barrier layer.
